(19) United States
(12) Patent Application Publication
(10) Pub. No.: US 2015/0258794 A1
(43) Pub. Date: Sep. 17, 2015

(54) Method of cleaning ink-jet nozzles

(71) Applicant: A-Tex Worldwide Sendirian Berhad, Ulu Tiram (MY)

(72) Inventors: Hann Sin Yong, Johor (MY); Sani Bin Sidik, Johor (MY); Zhen Hui Wong, Johor (MY)

(21) Appl. No.: 14/618,218

(22) Filed: Feb. 10, 2015

(30) Foreign Application Priority Data
Mar. 12, 2014 (MY) PI2014000707

(51) Int. Cl. B41J 2/165

(52) U.S. Cl. CPC B41J 2/16532

(57) ABSTRACT

A method of cleansing inkjet nozzles having multiple cycles used in sequence and utilizing various mediums like pressurized exhausting fluid and suctioning off ejected residues by way of suction device placed near ink nozzle.

### BACKGROUND OF THE INVENTION

1. Field of the Invention

This invention generally relates to ink jet printer apparatus and methods and more particularly relates to a cleaning system and method thereof.

2. Description of Related Art

Inkjet Printers are wonderful machines and has revolutionized the print industry like no others. It has brought down to size printing machines and made in-house printing a norm. Not only that, we will also see the possibility of 3D printing and the ability to print out organic body parts on demand and by individuals who need a replacement.

However, as good as the printer is, there are problems associated with printer nozzles. An ink jet printer produces images on a receiver by ejecting ink droplets onto the receiver in a dictated fashion. The ink that shoots out of the nozzle is in minuscule proportions and therein lays the problem. As printings are not continuous, tiny ink droplets can get dried out when it comes into contact with the environment, it inherently get stuck in the nozzle orifice, causing ink blockages and deflections. A printer will need a cleaning device and system and it is almost essential for industrial printers that have to be run continuously.

As a result of increased usage of printers in the market, various methods have been adopted to make printing effortless and less of a headache. The big question is how to get rid of ink residues stuck in the nozzle. One obvious method is to use an ink medium that does not dry fast. Unfortunately this can affect the printing speed and when we talk of industrial use, speed is the order of the day and fast drying ink is vital to profitability.

Generally, the chemical solvent Glycol facilitates good flow characteristics and is normally an essential ingredient of printer inks. Still, there are many types of particles floating around print nozzles and when the temperature rises, particles are formed and they stuck in the nozzle orifices giving printing problems.

Another often used method is to use a wiper. Wipers are made to contact the nozzle orifice and are usually made of easily wear off compounds. Some are even doused with a cleaning fluid so that they give a better cleaning. But because it touches the nozzle orifices, there is a problem like worn nozzle heads that needs expensive replacements. There is also no knowledge when a nozzle head will wear off and that normally will affect the up-time of the printer.

Yet another method is to use a form of spray of either a chemical cleaner or a neutral medium. But this method by itself is only good for cleaning the outside area of the nozzle. There is still a contention as to that residue that is stuck in the nozzle or near the nozzle. Another method adopted is the use of a ultrasonic inducer that promises to unstuck residue in the nozzle head. Although this enables continuous cleaning, an inherent vibration can dis-orientate parts that will ultimately need re-calibration. This is expensive and time consuming.

Another method according to U.S. Pat. No. 4,970,535 offers an air jet passageway. Air is directed through an inlet into a cavity. The air that enters the cavity is directed past inkjet nozzle and is said to clean off residues. However, blowing air (can be heated) is less effective for cleaning than use of a liquid solvent. Also, use of heated air creates its own turbulence and that can affect electrical circuits.

Therefore, an object of this invention is to provide a cleaning method that is robust and capable of increased productivity and that allows cleaning from within and without of the nozzle.

### BRIEF DESCRIPTION OF THE DRAWING

FIG. 1 is a cross sectional view of a printing nozzle.

FIG. 2 is a cross sectional view of a printing nozzle being purged of its ink.

FIG. 3 is a cross sectional view of a printing nozzle being sucked-off its ink residue.

FIG. 4 is a cross sectional view of printing nozzle being sprayed by a cleaning fluid.

FIG. 5 is a cross sectional view of a printing nozzle being again sucked off its ink residue.

### DETAILED DESCRIPTION OF THE INVENTION

According to a preferred embodiment of the present invention and with reference to diagrams shown above, a cleaning method on the print nozzle area is described comprises of four distinct steps performed in sequence. In order for the various steps to be taken, it is assumed that the overall design of the printing set-up provides for the various parts to be moved in relation to each other. Thus, when the printing stage is stop, print nozzle is moved into a position that is facing the suction device and the spraying nozzle. Alternatively, the printing nozzle remains static and the suction device or the spray nozzle moved into position facing the print nozzle. It is also inherent that during these exercise steps, the printing medium is shield away to prevent unwanted smudges. For effective cleansing, the printing stage will be disabled by way of control from operating software. Cleaning will take a few minutes depending on the number of print nozzles (10) but will generally not take more than 2 minutes.

### Cycle 1—Purging of Ink From Ink Nozzle (10)

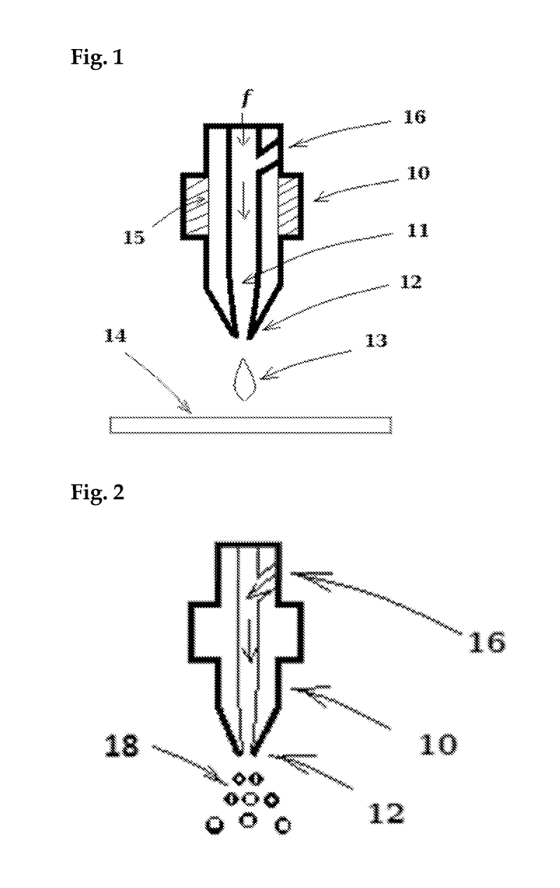

With reference to FIG. 1, as the print stage is stopped by switching off the ink injection mechanism, with the ink flow (f) stopped, a pressurized sterile fluid is then channeled into the ink flow channel (f) via inlet (16) of print nozzle (10). This will cause excess ink (13) in the nozzle orifice (12) to be ejected from the print nozzle (10). This cycle is engaged for two seconds and the effect is the exhaustion of excess ink and residue at or in the vicinity of the nozzle orifice (12). In order not to smear the printing medium (14) with reference to FIG. 1, the print nozzle (10) will be moved away from the print medium (14) or alternatively a barrier be inserted between them if the print nozzle (10) remains in their position.

Alternatively, the sterile fluid may contain cleaning chemicals to speed up cleaning cycles. An enhanced method of dislodging entrained ink residues at the nozzle orifice (12) is by way of subjecting the pressure fluid with resonating pulses. Yet another embodiment is to have a device emitting ultrasonic waves targeted at the nozzle orifice (12), such device may be incorporated at the tip point of suction device (16). Both ultrasonic waves and resonated pulses help to dislodge stubborn residues that can impede proper printings.

### Cycle 2—Vacuuming Off Ink Vapor from Surroundings

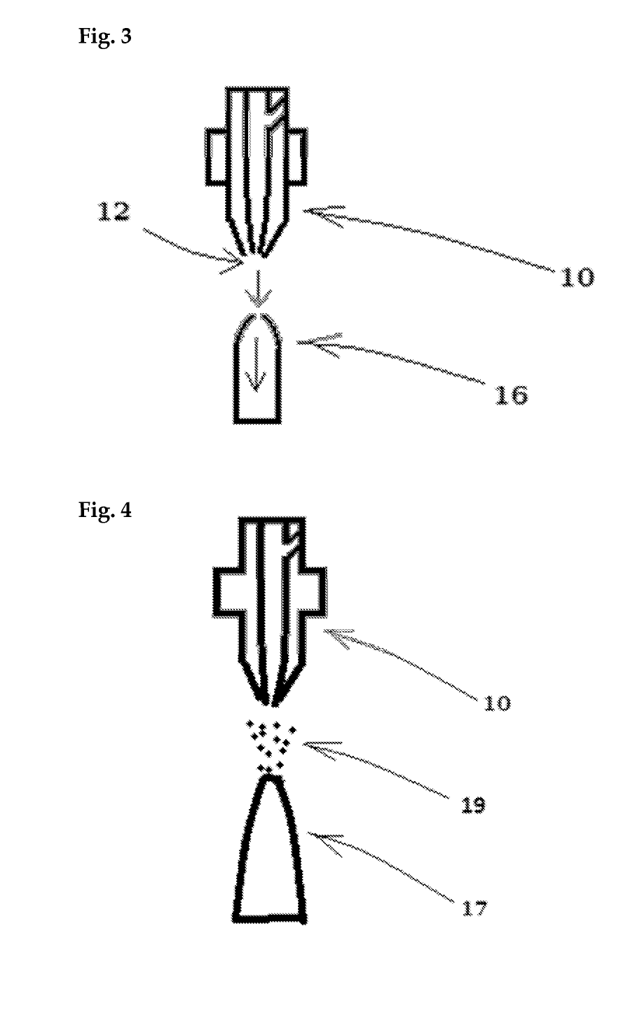

With reference to FIGS. 2, 3 and 4, a suction device (16) is moved into place facing directly but not touching print nozzle orifice (12). Alternatively, suction device (16) may be moved into place from a neutral position. In this stage and with the suction device (16) turned on, excess ejected ink vapor (18) surrounding the print nozzle orifice (12) is drawn away via suction device (16) shown by the arrow. This cycle will last a few seconds, depending on the complexity and number of print nozzles. This suction cycle will leave the area surrounding the print nozzle orifice (12) clean and bereft of ink vapor. It must be emphasized that the print nozzle (10) and the suction device (16) is moved away from the print medium (14) or a barrier be inserted between them.

### Cycle 3—Spraying with a Sterile Fluid

With reference to FIG. 4, a spray nozzle (17) is moved into place directly facing but not touching print nozzle orifice (12) where an ejection of fine cleaning fluid is sprayed on the surrounding area of print nozzle orifice (12) via spray nozzle (17). Cleaning fluid can be water or any appropriate medium. The spray will dilute any remaining ink vapor and also cleanses the nozzle orifice (12).

The orifice of the spray nozzles (17) is appropriately designed to give a fine mist spray with a given fluid pressure. This cycle will last a few seconds depending on the complexity and the number of print nozzles. The purpose is to dissolve away any remaining ink residue from the ink nozzle orifice (12). However, because of the spray, there will be a presence of fine mist particle including ink residue hovering around the print nozzle (10).

An alternative is to use a chemical cleaning medium in the spray, though in normal circumstances using an inert fluid will do the trick. This will be overcome in the next step and by also moving away the spray nozzle (17) from fronting the print nozzle orifice (12).

### Cycle 4—Second Time Suctioning of Vapor

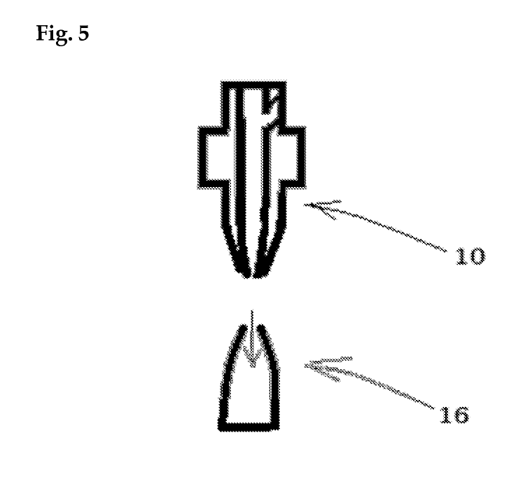

With reference to FIG. 5, a suction device (16) is again moved into position facing directly print nozzle orifice (12) but not touching. The suction device (16) will be powered for a few seconds, depending on the complexity and number of print nozzles. When the vacuuming has taken place and residues removed, the suction device (16) will be removed away. This step will remove any remaining mist residue (18) and will prepare for the next printing stage.

From the above description, it would be seen that a practical system is adopted where cleaning is both done inside and outside of the print nozzle (10) which will overcome some of the problems associated with other methods. The system is designed in sequential steps which will also allow an easy method of disassembly of the various parts for maintenance purposes. Since the various parts do not come to touch each other, we can be assured that there are very little dis-orientations of the various parts to ensure perfect printing.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for removing ink residues from an inkjet print nozzle having a nozzle orifice, said method comprising:
a) applying a pressured sterile fluid to exhaust the nozzle orifice of ink and residues on the surface thereof;
b) applying vacuuming of exhausted ink and residue from an area surrounding the nozzle orifice via a suction device mounted and moved into place facing the nozzle orifice;
c) applying a pressured fluid mist to dissolve surrounding exhausted ink vapor and residues entrapped in the nozzle orifice by way of a spray nozzle moved and in-placed facing the nozzle orifice;
d) removing exhausted ink vapor and residue from an area surrounding the nozzle orifice via the suction device moved again to face nozzle orifice.

2. The method of claim 1 wherein the pressured fluid used for exhausting nozzle orifice ink from fluid inlet is subjected to resonating pulses.

3. The method of claim 1 wherein the pressured fluid for exhausting nozzle orifice ink contains chemical cleaners.

4. The method of claim 1 wherein the pressured fluid for exhausting nozzle ink contains chemical cleaners as well as subjected to resonating pulses.

5. The method of claim 1 wherein the pressured fluid for exhausting nozzle ink is heated to a temperature suitable for dislodging deposits.

6. The method of claim 1 wherein the suction device is designed with an adjustable intake point that allows better focusing as the suction device approaches but does not touch the nozzle orifice.

7. The method of claim 1 wherein the suction device has a head element to emit a high intensity acoustic pulse focusing at the nozzle orifice to dislodge obstinate ink deposits.

8. The method of claim 1 wherein said nozzle orifice is made to confront but not touching a single devise head element capable of performing suction and spraying action in a sequential mode.
